(19) United States
(12) Patent Application Publication
(10) Pub. No.: US 2025/0310387 A1
(43) Pub. Date: Oct. 2, 2025

(54) SHARED APPLICATION CONTEXTS DURING VIDEO CONFERENCES

(71) Applicant: Zoom Video Communications, Inc., San Jose, CA (US)

(72) Inventors: Evgeny Balashov, Burbank, CA (US); Christopher Allen Alexander Goodine, Westport (CA); Arun Janakiraman, San Francisco, CA (US); Ross Douglas Mayfield, Palo Alto, CA (US)

(73) Assignee: Zoom Video Communications, Inc., San Jose, CA (US)

(21) Appl. No.: 18/621,836

(22) Filed: Mar. 29, 2024

(51) Int. Cl. H04L 65/401; G06F 3/0484; H04L 65/1093

(52) U.S. Cl. CPC H04L 65/401; H04L 65/1093; G06F 3/0484

(57) ABSTRACT

Techniques for implementing shared application contexts during video conferences are disclosed. In an example method, a first client device joins a video conference hosted by a video conference provider. The first client device receives, from a second client device, a network address. The first client device receives, from the video conference provider, information about the network address based on the network address. The first client device renders and displays the information about the network address, in which the rendering includes one or more controls, each control associated with an action to take in response to selecting the control. The first client device receives an indication of a selection of a first control of the one or more controls. The first client device outputs a command to execute the action associated with the first control.

### FIELD

The present application generally relates to collaborative software applications, and more particularly relates to techniques for establishing a shared application context during video conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for using shared application contexts during video conferences, according to some aspects of the present disclosure.

FIG. 4 shows an example of a system that implements shared application contexts during video conferences, according to some aspects of the present disclosure.

FIG. 5 shows an example of another system that implements shared application contexts during video conferences, according to some examples of the present disclosure.

FIG. 6 shows an example of a user interface that may be provided by a client device that implements shared application contexts during video conferences, according to some examples of the present disclosure.

FIGS. 7A-7B show additional examples of user interfaces that may be provided by a client device that implements shared application contexts during video conferences, according to some examples of the present disclosure.

FIG. 8 shows yet another example of a user interface that may be provided by a client device that implements shared application contexts during video conferences, according to some examples of the present disclosure.

FIG. 9 shows a flowchart of an example method for providing shared application contexts during video conferences by a client device in a video conference, according to some aspects of the present disclosure.

FIG. 10 shows a flowchart of another example method for providing shared application contexts during video conferences by a server such as a video conference provider, according to some aspects of the present disclosure.

FIG. 11 shows a flowchart of yet another example method for providing shared application contexts during video conferences by a client device in a chat channel, according to some aspects of the present disclosure.

FIG. 12 shows an example computing device suitable for use in example systems or methods for providing shared application contexts during video conferences, according to some aspects of the present disclosure.

### DETAILED DESCRIPTION

Examples are described herein in the context of shared application contexts during video conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Modern video conferencing platforms can serve as communication hubs, bringing together a nexus of applications and data including video, chat, email, calendaring, and more. For example, client software for video conferencing can enable video conference participants to greater heights of productivity through the incorporation of other applications into the video conferencing experience. Such applications can be used for collaboration during a video conference to maximize the utility of the video conferencing medium.

For example, video conference client software may include screen sharing capabilities. During screen sharing, a number of video conference participants can view the actions of another video conference participant using an application such as a web browser. For instance, a first participant may open a document in a web browser and then share her screen during a video conference. The video conference participants can then collaboratively edit the document through discussion while the observing the actions of the first participant or directing the first participant. Collaboration through screen sharing is a passive, constrained experience, however, since it is not truly collaborative in many cases where only one participant can interact with the document at a time.

Another avenue for collaboration involves the use of collaborative applications. For example, some video conference client software includes integration with first-or third-party applications. Video conference participants may desire to collaborate using a cloud-based design tool that provides an integration that can be used from within the video conference client software during a video conference. Video conference participants can simultaneously use the integration provided by the cloud-based design tool and collaborate on shared design documents during the video conference. Web browsing may also be a collaborative experience in which the web browser itself is the collaborative application.

In both of these examples, however, the collaborative experience can be hampered by the disparate client software configurations of the various video conference participants. For example, consider an example in which a host video conference participant pastes a link to a collaborative application into the video conference chat with the aim of collaborating over a document. The first participant may have the collaborative application installed locally as a native desktop application. A second participant may only have the collaborative application installed as a third-party integration with the video conference client software. A third participant may not have the collaborative application installed anywhere, although installation may be available. A fourth participant may not have the collaborative application installed anywhere and may be using a computing system that does not support installation of the application.

For each of these example participants, selecting the link in the video conference chat will result in a different user experience with varying degrees of barriers and delays to collaboration. The first participant may be surprised to be automatically switched out of the video conference client software to the native desktop application. The second participant may find the third-party integration started but not opened to the collaborative document, as desired. The third participant may only experience an error message expressing that the application is not found or may be switched out of the video conference client software to a web browser. The fourth participant may similarly experience an error message that expresses the lack of available installation options.

In these cases, collaboration may require numerous clicks, logins, configurations, or installations before collaboration can begin. In some cases, participants may simply default to using collaborative applications in a web browser simply because it is the fastest path to productivity, at the expense of the array of functionality afforded by the collaborative applications themselves. In some cases, participants may fall back on the least-collaborative option, screen sharing, because it reliably works without delay. These and a constellation of related challenges can prevent a seamless collaborative user experience, needlessly consuming time and resources.

These challenges can be addressed using techniques for shared application contexts during video conferences. For example, a video conference participant can invite other participants to collaboratively edit a document using a third-party application with an available integration with the video conference client software. The video conference participant can share a link associated with the document with other participants that can be “unfurled” using, for example, a chat application. In this context, unfurling refers generally to the process of automatically expanding links, URLs, or other references into rich preview cards or embedded content directly within the containing chat message. For example, the unfurled link can display information such as the installation status of the integration, login or authentication information, preview graphics, and so on. The unfurled link can further include a user interface that can be used to improve the collaborative user experience.

The following non-limiting example is provided to introduce certain concepts. In an illustrative method, a first client device joins a video conference with a number of participants hosted by a video conference provider. The first client device receives, from a second client device, a network address, such as a uniform resource locator (URL) or “link,” that is indicative of a desire to collaborate by the second client device using a particular application. For example, the URL may encode the desired particular application for collaboration, authentication information, a specific document for collaboration, or other configuration information.

The first client device then receives, from the video conference provider, additional information based on the URL. The URL and the received additional information based on the URL are, collectively, an example of a shared application context. A shared application context can refer generally to a collection of information about a network address (including the network address itself) that can be used to, for example, generate and provide a user interface that can be used to initiate or join a collaborative session using an application with other users.

The additional information based on the URL can be used to display an unfurled network address in a chat interface. The unfurled network address may include information about the network address presented as a user interface, including labels, graphics, controls, etc. For instance, the additional information may include a thumbnail preview of the document for collaboration, the title of the document, text to display, or instructions for displaying a user interface. The particular user interface rendered on a given client device may vary depending on the particular configuration of the client device.

For instance, if the collaborative application is installed on the first client device, the user interface shown on the first client device may show controls for starting the application or opening the document. If the collaborative application is not installed on the first client device, in contrast, the user interface shown on the first client device may shown controls for installing the application or for opening the application in another context outside the video conference client software such as a web browser.

The first client device then unfurls the network address by generating and displaying a rendering of the information about the network address, including user interface controls based on the configuration of the first client device in a chat interface that is part of the video conference user interface. The unfurled network address may include other information about the network address such as a thumbnail preview of the document for collaboration, the title of the document, descriptions, information about the collaborating participants, and so on.

The first client device then receives an indication of a selection of one of the rendered user interface controls and outputs a command to execute the action associated with the control. For example, a user interface control such as a button labeled “Install this App” can cause the execution of a process on the first client device to install the application integration.

The innovations of the present disclosure provide significant improvements in the technical field of software applications in the context of video conferences. The development of a seamless collaborative user experience and improved efficiency with respect to collaboration is accompanied by a number of optimizations of the consumption of computing resources. For example, existing systems, upon receipt of a network address may naively display associated information without first determining authentication status, installation status, or application support status, resulting in needless or redundant rendering of unfurled network addresses. Likewise, existing systems may involve each client device involved in a collaboration to perform unfurling steps, including the determination of the content of the unfurled network addresses, resulting in multiple redundant determinations. Such determinations can be centralized to the video conference provider using the techniques disclosed herein.

Importantly, overall consumption of computational resources may be reduced by directing video conferences to uniform application experiences rather than defaulting to a web browser in all cases. Use of a web browser may consume more computing system resources in any case, relative to a lightweight video conference client software integration that does not require a context switch to a process outside the client software. Similarly, the client software integration can partially reside in the memory used by the client software along with suitable cache mechanisms, further improving on the computing performance and consumption of processing and resources demanded through a web browser.

These illustrative examples are given to introduce the reader to the general subject matter discussed herein and the disclosure is not limited to these examples. The following sections describe various additional non-limiting of examples of establishing a shared application context during video conferences.

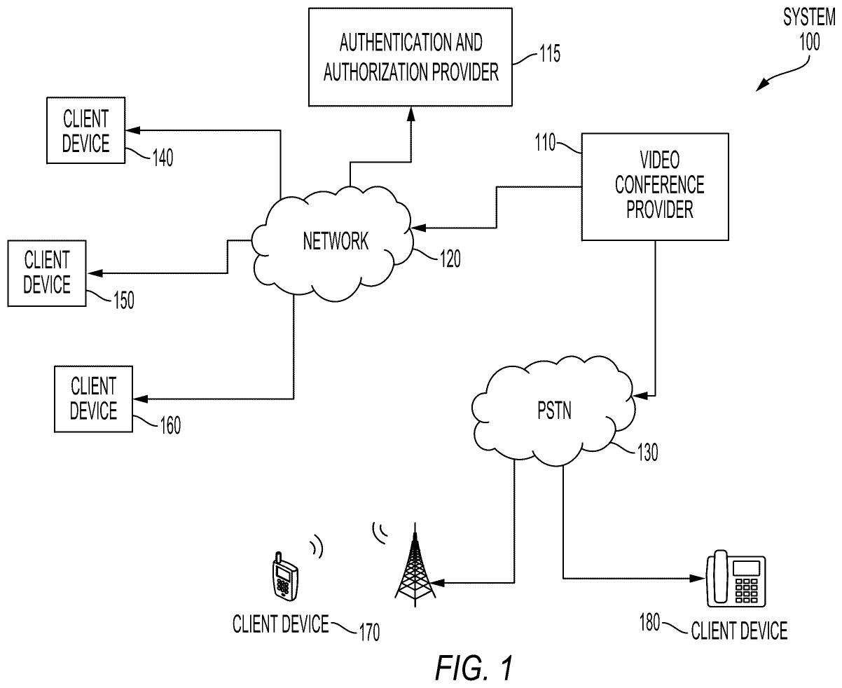

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

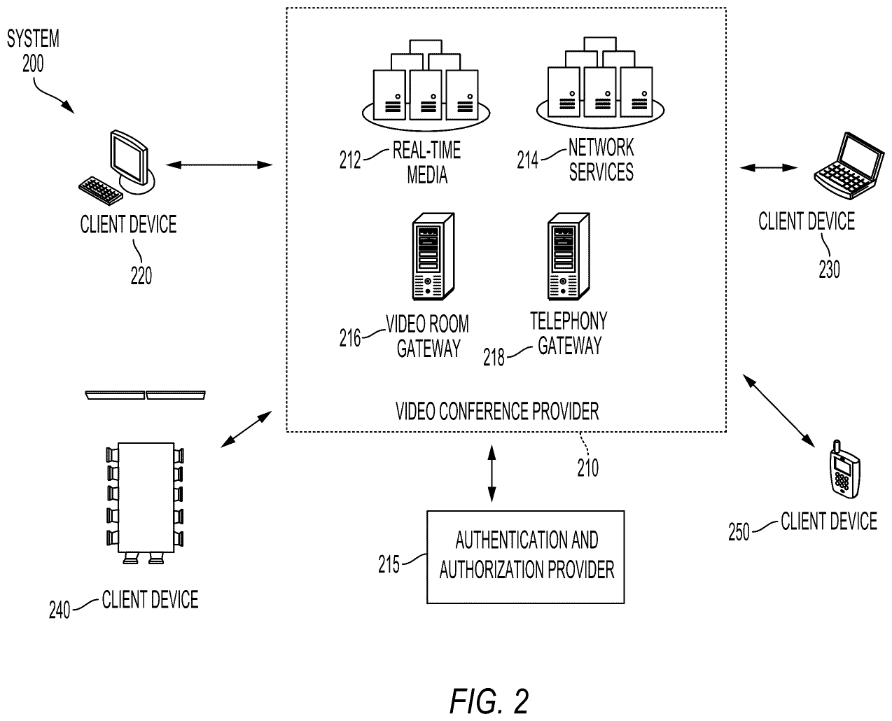

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

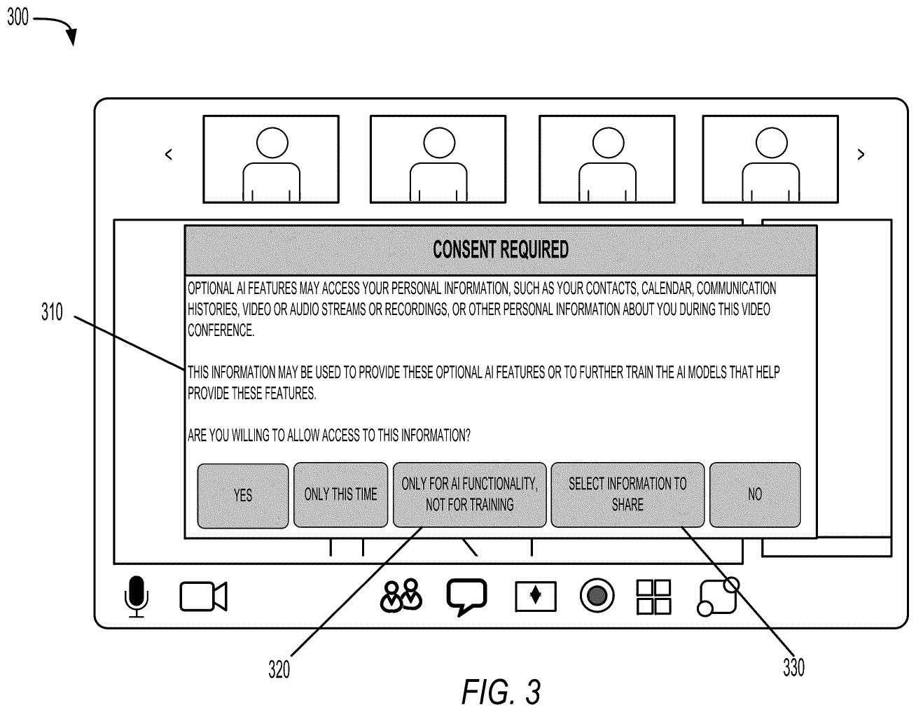

Turning next to FIG. 3, FIG. 3 shows an example user interface 300 that may be used in some example systems configured techniques for establishing a shared application context during video conferences. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

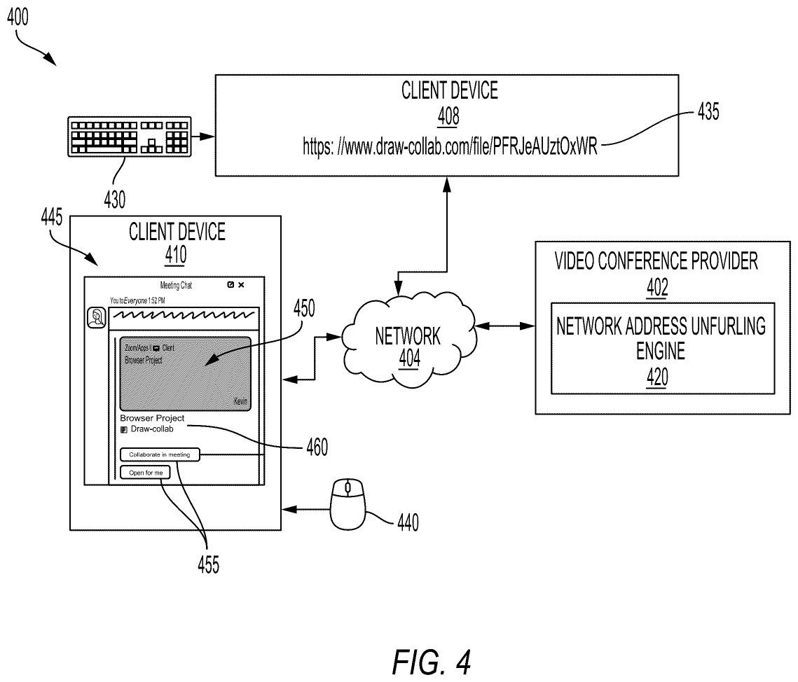

Referring now to FIG. 4, FIG. 4 shows an example of a system 400 that implements shared application contexts during video conferences, according to some aspects of the present disclosure. System 400 includes two client devices 408, 410 communicatively coupled with video conference provider 402 over a network 404. Network 404 may include the Internet, public networks, private networks, or combinations thereof. Video conference provider 402 is typically a server or collection of servers, including a combination of privately or cloud-hosted devices. Video conference provider 402 may be similar, in some respects, to the video conference providers 110, 210 described above with respect to FIGS. 1 and 2.

Client devices 408, 410 may be any type of device capable of executing the appropriate client software implementing certain aspects of shared application contexts during video conferences. For example, the client devices 408, 410 may be laptops, desktops, smartphones, tablets, internet protocol (IP) phones, and so on. Client device 408 includes a keyboard 430, which is an example of an input device that can be communicatively coupled to the client device 408 to receive shared application contexts. Other input devices can be similarly used for inputting shared application contexts such as touchscreen keyboards, microphones, and the like. For instance, client device 408 can receive, using keyboard 430, a shared application context identified using a network address such as URL 435.

The example URL 435 identifies a shared network context through specification of a hostname (“www.draw-collab.com”), an application or function designation (e.g., “file”), and a file (e.g., “PFRJeAUztOxWR”). For example, in URL 435, these three specifications (e.g., hostname, application or function, file) together specify a shared application context. The URL 435 can be input using, for example, keyboard 430 and sent to other client devices (e.g., second client device 410) during a video conference hosted by video conference provider 402.

The example of URL 435 and the components enumerated therein, are intended to be illustrative only. More or fewer elements can be used in various examples, to identify a shared network context. A shared network context can be identified using, for example, network addresses such as IP addresses, MAC addresses, port numbers, protocol identifiers, network file locations, email addresses, and so on. A shared network context can also include, in addition to a network address, additional data as may be encoded or stored in a URL query string, HTTP message body, file metadata, and so on. In some examples, a shared network context may be identified using a network address, which can in turn be used to look up additional information about the shared application context in a database or other persistent storage facility.

The video conference provider 402 includes a network address unfurling engine 420. The network address unfurling engine 420 can receive a network address such as URL 435 and generate information about the received network address. For example, the network address unfurling engine 420 may populate a suitable data structure that includes various elements that can be used for generating the unfurled network address 445 such as rendering instructions (e.g., an HTML template), images (e.g., a preview or “snapshot” image of a webpage), a title of the webpage, or a sampling of text from the webpage.

For instance, the URL 435 may be sent by client device 408 using a chat interface. The URL 435 can be received by the second client device 410 and shown in chat interface 445. Chat interface 445 shows an unfurled network address 445. An unfurled network address may include a preview graphic 450, user interface controls 455, descriptive text 460, and so on.

The unfurled network address 445 and, in particular, the user interface controls 455 can then be used to, for example, initiate the collaborative session by a user of the second client device 410. The second client device 410 can receive an indication of a selection of one or more of the user interface controls 455 from an input device such as mouse 440. The second client device 410 can then output a command to execute the action indicated by the selection of the one or more of the user interface controls 455. For instance, for the example user interface controls 455, a user of the second client device 410 may click the “Collaborate in a meeting” button using mouse 440. Clicking the “Collaborate in a meeting” button may cause the application associated with the “www.draw-collab.com” hostname to open an integration within the video conference client software or an associated web application in a web browser in a collaborative session.

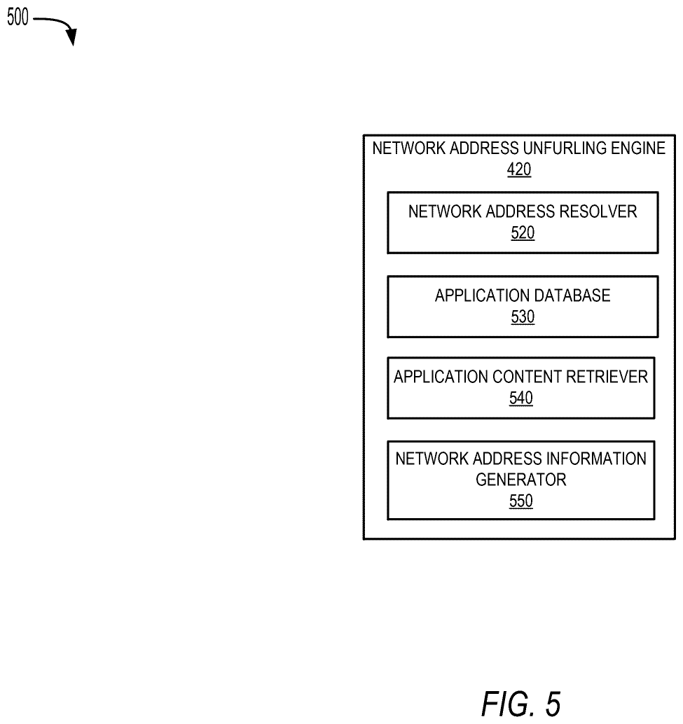

Referring now to FIG. 5, FIG. 5 shows an example of another system 500 that implements shared application contexts during video conferences, according to some examples of the present disclosure. System 500 shows an example implementation of the network address unfurling engine 420. However, the implementation depicted in FIG. 5 and system 500 is just an example, and other implementations are possible.

Network address unfurling engine 420 includes a network address resolver 520. The network address resolver 520 can parse a received network address to determine portions of the network address needed for generation of the information about the network address. For example, a network address that is a URL can encode information such as a hostname, an application name, a network location, a particular document, authentication or authorization information, application parameters, and so on. In some examples, the network address resolver 520 determines a hostname or application name from the network address and queries the application database 530 to determine the appropriate application to use for the collaborative session and, thus, the generation of the information about the network address.

For example, one network address may be a URL that points to a web application, such as “https://www.draw-collab.com/file/PFRJeAUztOxWR.” In this example, the web application hostname may correspond to the application. The hostname can be used as a key to look up the corresponding application in application database 530. Application database 530 may be a standalone relational database (e.g., a SQL-based database), a file, key-value storage application, a cloud storage location or storage provider, and so on. Application database 530 may also provide additional elements for generation of the information about the network address.

For example, if the network address corresponds to a webpage such as a web application, then the application database 530 may, in to identifying the application based on the hostname, may also provide instructions for rendering the information about the network address, such as an HTML template for the unfurled network address. The HTML template may include, for example, a preview or “snapshot” image of the webpage, a title of the webpage, or some portion of text retrieved from the webpage.

In some examples, the hostname may not be resolvable on the Internet and may refer to, for example, a locally installed application. For example, another network address may be a URL that points to a locally installed application with a hostname registered with the client device, such as “http://draw-collab/file/PFRJeAUztOxWR.” In this case, the hostname “draw-collab” may be a string that is registered with the client device to identify a locally installed application. As with the web application example, the hostname can be used as a key to look up the correspond application in application database 530.

In this example, in which the network address refers to a locally installed application, the information about the network address as obtained from the application database 530 may include information about the application, such as the name of the application and commands for accessing the application, such as a button to launch the application. The information about the network address may also include instructions for rendering the information about the network address, such as an HTML template for the unfurled network address, similarly to the example given above for a web application.

The preview of the application may be based on information about the first client device. In this case, the preview or “snapshot” image may be, for example, a predetermined image associated with the application or a preview generated based on the information encoded in the network address (e.g., a snapshot of the collaborative file generated using an application programming interface (API) of the application. For example, the information about the network address may include default information about the application including a default image to show in the unfurled network address.

In this example, the hostname “www.draw-collab.com” identifies the application, which may be “MyDraw Collaboration Application.” The application may be accessible using a web application on the Internet and may also have published integration with the video conferencing software in use. For example, if a user does not have the application installed locally, either as a third-party plug-in or as a native application, the video conference provider 402 may provide an app store or marketplace where third-party integrations can be downloaded and used during video conferences. Users may be free to use either or both of the web version or the integration version. Other versions of the application may be available such as native application, command-line applications, mobile applications, and so on.

Network address unfurling engine 420 includes an application content retriever 540. The application content retriever 540 can retrieve assets used in displaying unfurled shared application contexts. For example, the information about a network address such as a URL corresponding to a webpage may include an HTML template for the unfurled network address. The HTML template may include a block or placeholder for a preview or “snapshot” image of the webpage. The application content retriever 540 can use a web browser, web scraper, or other suitable HTTP client to access the webpage specified by the URL and obtain a screenshot in accordance with the information about the network address.

Network address unfurling engine 420 includes a network address information generator 550. The network address information generator 550 can instantiate a suitable data structure corresponding to the various elements of the information about the network address. The data structure can be populated by the network address information generator 550 according to the information determined by the network address resolver 520 and retrieved from the application database 530 or application content retriever 540. The network address information generator 550 can send the populated data structure to the client devices 408, 410 using a suitable serialized format (e.g., JavaScript Object Notation (JSON)), which can subsequently display the unfurled information about the network address and the appropriate user interface controls.

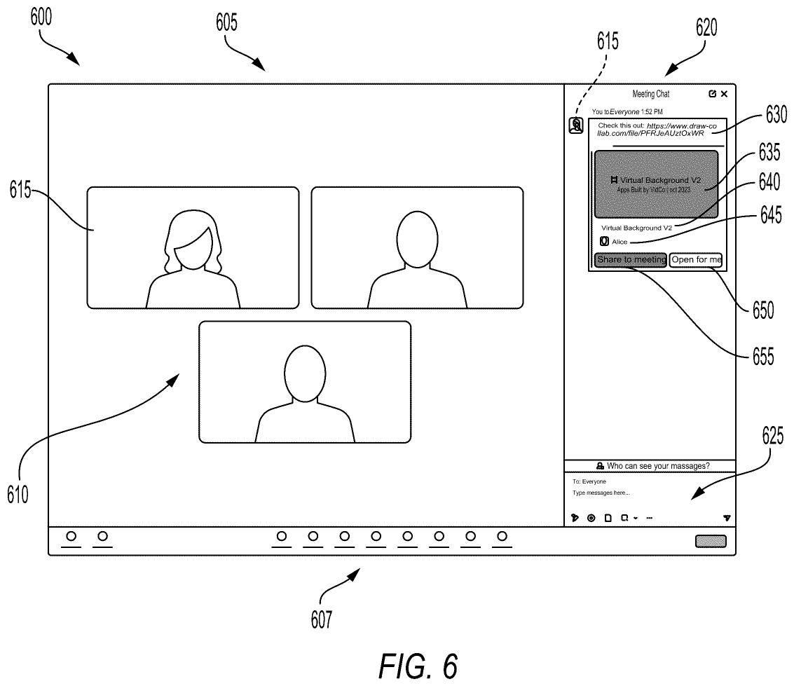

Referring now to FIG. 6, FIG. 6 shows an example of a user interface 600 that may be provided by a client device that implements shared application contexts during video conferences, according to some examples of the present disclosure. The user interface 600 depicts an in-progress video conference. The user interface 600 includes a main viewing window 605 that shows a number of participants 610. In this example user interface 600, main viewing window 605 also includes a set of meeting controls 607 that may used for controlling functions such as audio controls, video controls, video conference security, screen sharing, application or integration controls, and so on.

Among the participants 610 is a first participant 615 that may desire to collaborate with the other participants 610 using a collaborative drawing program. The first participant 615 may, for example, be using a web application provided by the collaborative drawing program. For live collaboration during the video conference, the first participant 615 can opt to use screen sharing, but this suffers from a number of deficiencies as outlined above.

An optimized user experience is available to the first participant 615 using the innovations disclosed herein. In some examples, the first participant 615 may instead obtain a network address that encodes various specifications of the desired collaboration. For example, if the network address is a URL, the URL may include encoded information about the application, the particular function of the application, a specification of the document over which to engage in collaboration, authentication information, and so on.

The first participant 615 can copy the network address using, for example, a clipboard function of their client device and paste the network address into the chat window 620 included in the user interface 600 for video conferencing. For instance, the network address can be pasted into the chat message entry controls 625. If the user is working in an application integrated into the video conferencing client, the application may provide an option to collaborate, which may generate and insert a suitable network address into the chat in response to the user selecting the collaborate option.

The network address may be sent to the other participants 610 via, for example, the video conference provider 402. The video conference provider 402 may include a network address unfurling engine 420 that can generate information about the network address based on the information it encodes. The information about the network address can be sent to the client devices 408, 410 and be used to render an unfurled network address 630.

The chat window 620 can then display the unfurled network address 630. The unfurled network address 630 may be displayed as, for example, a URL that can operate as a hyperlink. The unfurled network address 630 may include an image or snapshot 635 of the application. For example, the image or snapshot 635 may show a snapshot of the document to be collaborated over, a generic image provided by the application, a generated image containing information about the document or the application, and so on. In some examples, what is shown for the image or snapshot 635 can be configured by the client device, by the host, by the application developers, or other suitable source of configuration data.

The unfurled network address 630 further includes a title 640. The title may correspond to the name of the application, the document for collaboration, or other suitable label. The unfurled network address 630 further includes an author 645. The author 645 may be, for example, the author of the document for collaboration, the author of the application, or other suitable content creator associated with the collaborative effort.

The unfurled network address 630 includes controls 650, 655. The controls 650, 655 may vary according to the particular client device 408, 410. For example, the unfurled network address 630 can be configured to display certain controls if the corresponding application is locally installed, accessible, logged into, or currently open, among various other possible statuses. Likewise, a different or additional controls may be displayed if the application is in opposite or incompatible statuses. In some examples, a default set of controls may be displayed by the unfurled network address 630 where determinations about the application status cannot be made (e.g., due to security settings).

For example, if the corresponding application is locally installed but not running the controls 650, 655 may correspond to commands to start the locally installed application and then open the document for collaboration. In another example, if the corresponding application is locally installed but already running the controls 650, 655 may correspond to commands to switch the operating system context to the running application and then open the document for collaboration. In yet another example, if the corresponding application is installed as an integration with the video conference client software, the controls 650, 655 may correspond to commands to execute or otherwise start the integration using an API provided by the video conference client software and then open the document for collaboration within the integration. In yet another example, if the corresponding application is not locally installed, the controls 650, 655 may correspond to commands to display a user interface for guiding the user through an installation process. Following the installation process, a subsequent command may then open the document for collaboration within the integration.

In this example, the unfurled network address 630 is a URL that corresponds to a web application that may also be installed locally (e.g., as an integration into the video conference client software or as a natively installed desktop application). The first control 650, labeled “Open for me,” can be used to open the web application in a non-collaborative mode, such that only the user of the associated client device is able to view and interact with the thus-opened application. The first control 650 may cause the application to open in a web browser, in a locally installed desktop or mobile version, in an integration in the video conference client software, or other implementation. The second control 655, labeled “Share to meeting,” may cause the application to open in a collaborative mode.

The example second control 655 may be displayed, for example, to the particular participant 615 that posted the network address, to initiate the collaboration. The example unfurled network address 630 shown in FIG. 6 is representative of what the sending client device may experience, but similar user experiences could obtain for the receiving client devices. For instance, a receiving client device may instead see a second control 655 labeled as “Open shared document” to cause the application to open in a web browser, in a locally installed desktop or mobile version, in an integration in the video conference client software, or other implementation in a configuration in which both the sending and receiving client devices can collaborate together.

In some other examples, a control may be displayed that can cause the webpage to open in a collaborative web browser on each client device of the plurality of client devices. For example, the video conference client software may include a collaborative web browser that enables video conference participants 610 to simultaneously interact with a webpage. In some examples, a control may be displayed that can cause the webpage to open in a preview web browser on the first client device. For example, the video conference client software may include a preview web browser that can open the webpage in a sidebar or similarly minimized framing. The preview web browser can be used to view the application before engaging in collaboration. In some examples, a control may be displayed that can cause the webpage to open in a web browser application. For instance, a locally installed web browser may include one or more installed plugins corresponding to the application specified in the network address. Using this control can cause the application to open in the context of a suitable plugin or using the unadorned functionality of the web browser such as in a single-page application or conventional web application.

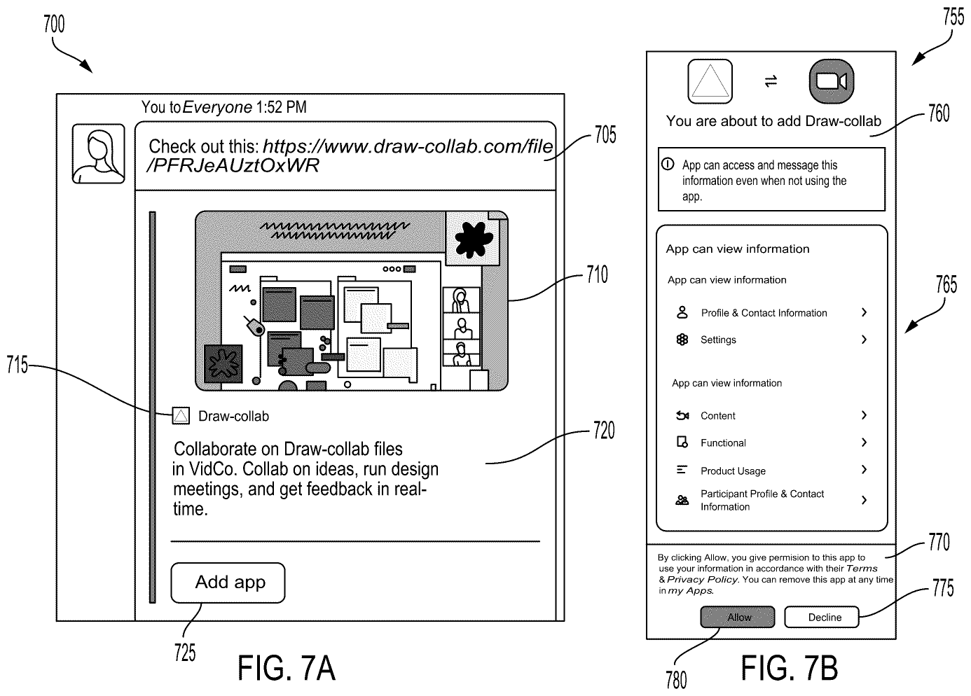

Referring now to FIGS. 7A-7B, FIGS. 7A-7B show additional examples of user interfaces 700, 750 that may be provided by a client device that implements shared application contexts during video conferences, according to some examples of the present disclosure. User interface 700 shows another example of an unfurled network address 705 that corresponds to an application identified by a URL that may be shown when the network address corresponds to an application and the application is not installed on the first client device. Unfurled network address 705 includes an image or snapshot 710, an application developer label 715, and descriptive text 720. Other user interface elements may be similarly included in unfurled network address 705 as may be indicated using an HTML template associated with the network address.

Unfurled network address 705 may include a control 725 to cause the application to be installed on the client device. In this example, the control 725 is labeled “Add app” which can, upon selection, cause processes to initiate an installation of the application on the client device. For example, the control 725 may cause an initiation of a process to install an integration within the video conference client software, to install a native desktop or mobile application, to install a web browser plugin, or other process to cause a local installation of software associated with the application.

User interface 750 in FIG. 7B shows an example of a user interface that may be shown following selection of the control 725. In this example, the control 725 has caused initiation of the installation of an integration associated with the application within the video conference client software. For example, the process may install a first-or third-party application, an integration, plugin, add-on, and so on.

User interface 750 includes a header including information about the integration such as the name of the integration, developer logo, application logo, and so on. User interface 750 includes permissions information 765 that can include information about the permissions that will be required or granted to the integration upon installation. User interface 750 also includes an associated permissions warning 760 that can include additional information about permissions that may, for example, have security implications. User interface 750 includes a legal statement 770 that may include legal information relating to the installation of the integration such as privacy statement or terms of service. User interface 750 includes an allow control 780 and a decline control 775 that can be used for providing an indication of whether or not to install the application integration in accordance with the permissions and legal information provided above. In some examples, the user interface 750, including controls 780 and 775, may be provided by the video conference client software, apart from the user interface provided by unfurled network address 705.

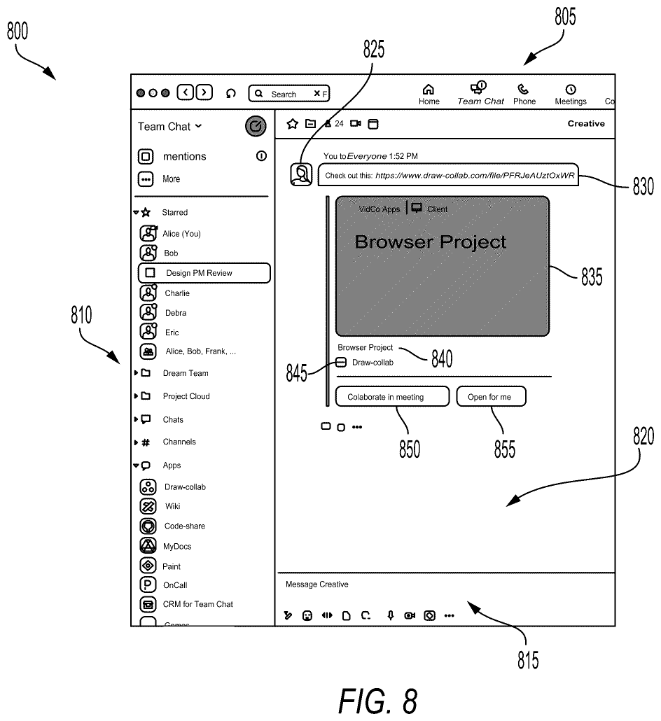

Referring now to FIG. 8, FIG. 8 shows yet another example of a user interface 800 that may be provided by a client device that implements shared application contexts during video conferences, according to some examples of the present disclosure. User interface 800 depicts an example of shared application contexts as may be seen in the context of a chat channel application provided by the video conference client software.

The user interface 800 may include top controls 805 for navigating among the primary functions of the video conference client software such as the home screen, the chat channel application, a telephone application, a video conference application, and so on. Top controls 805 may include a search function and navigation function (e.g., back/forward/reload buttons).

The user interface 800 includes a navigation bar 810 that may include, for example, chat rooms, chat channels, group chats, one-on-one chats, starred or favorited chats, and so on. The user interface 800 includes chat message entry control 815 for entering, formatting, and sending chat messages, attachments, emojis, and so on. User interface 800 includes a main chat window 820 that shows sent and received chat messages as well as, for example, unfurled network addresses. It should be appreciated that the top controls 805, navigation bar 810, chat message entry control 815, and main chat window 820 are merely examples of chat channel applications that may vary among various embodiments and implementations.

User interface 800 depicts an unfurled network address 830 sent by participant 825 for an application. Similar to the user interfaces 600, 700, the unfurled network address 830 includes an image or snapshot 835, a title 840, an author or content creator 845. The unfurled network address 830 also includes control 850 for starting a collaborative session or control 855 for starting an individual, non-collaborative session for the user of the client device displaying user interface 800, which may be a non-collaborative session.

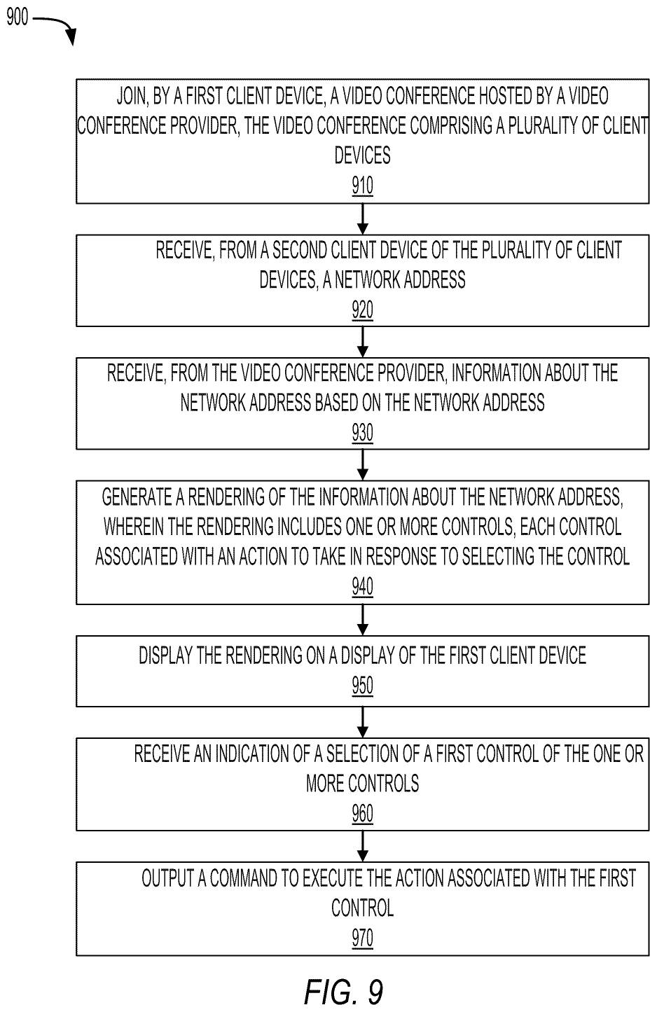

Referring now to FIG. 9, FIG. 9 shows a flowchart of an example method 900 for providing shared application contexts during video conferences by a client device in a video conference, according to some aspects of the present disclosure. The description of the method 900 in FIG. 9 will be made with reference to FIGS. 4-8, however any suitable system according to this disclosure may be used, such as the example systems 100 and 200, shown in FIGS. 1 and 2.

It should be appreciated that method 900 provides a particular method for providing shared application contexts during video conferences. Other sequences of operations may also be performed according to alternative examples. For example, alternative examples of the present disclosure may perform the steps outlined above in a different order. Moreover, the individual operations illustrated by method 900 may include multiple sub-operations that may be performed in various sequences as appropriate to the individual operation. Furthermore, additional operations may be added or removed depending on the particular applications. Further, the operations described in method 900 may be performed by different devices. For example, the description is given from the perspective of a client device (e.g., client device 410) but other configurations are possible. One of ordinary skill in the art would recognize many variations, modifications, and alternatives.

The method 900 may include block 910. At block 910, a client device joins a video conference hosted by a video conference provider. The video conference may include a number of client devices. Various video conference participants may be using the respective client devices and may further desire to initiate a collaborative session over an application such as a word processor, graphics editor, web browser, video editing application, among many other possibilities.

Each application may have numerous corresponding implementations. For example, each application may have one or more of a first-or third-party integration with the video conference client software, a web application, one or more standalone native applications, mobile applications, command line applications, and so on. Each client device may, in turn, have one or more of the available implementations installed or accessible. For instance, for a given graphics application, a first client device may have a third-party integration installed, a second client device may have a native application installed, while a third client device may have no implementations installed. The participants associated with each respective client device may additionally desire to operate the application using a particular implementation. For example, the user of the second client device, while having the native application installed, may nevertheless desire to conduct a collaborative session using the web application in a web browser.

At block 920, the client device receives, from another client device of the number of client devices, a network address. For example, the participant using the other client device may desire to collaborate using an application during the video conference. The participant may use a function of the application to export a network address that can be shared with other users for collaboration purposes. For example, the application may be provide a control to generate a network address such as a URL, such as URL 435 in FIG. 4. The network address may sent to the other participating client devices via the video conference provider.

At block 930, the client device receives, from the video conference provider, information about the network address based on the network address. For example, upon receiving the network address during its transmission among the client devices, the network address can be processed by the video conference provider or other suitable server component using a component such as the network address unfurling engine 420 depicted in detail in FIG. 5 and described in the accompanying description. The network address unfurling engine 420 can generate information about the network address including instructions for rendering the information about the network address (e.g., an HTML template), an image or snapshot of the application, a name or title of the application, a portion of text derived from the application or the document identified for collaboration.

In some examples, the information about the network address may further include authentication information. For example, for collaboration among the various client devices, the application may require users to be authenticated or authorized. In the former case, users may be required to, for example, create user accounts or log in prior to commencement of the collaborative session. In the latter case, authorization to use the application or collaborate over a particular document may be delegated or otherwise authorized by the sending user. In this case, the information about the network address may include authorization information such as a token or URL string that indicates that the user is authorized to access the application or a specific document available therein.

In some examples, the video conference provider can include a scope associated with the received network address. The scope may be associated with an authentication information request. For example, the scope may specify a particular range or enumeration of permissions or authorizations that can be associated with the network address. For instance, the scope can include information that specifies that authorized “read” access is required to render the unfurled network address with a particular subset of information. In another example, the scope can include information that specifies that authorized or authenticated members of an “admin” group or role can view the unfurled network address with another particular subset of information.

The client device can then output, to the video conference provider, authentication information about in response to the specified scope. For example, if the scope requires authorized “read” access, the client device can provide an indication of such an authorization (e.g., a security token) to the video conference provider. The video conference provider can then provide the information about the network address based on the authentication information about the first client device.

In some examples, the video conference provider can output network address and authentication information about the client device to a webhook endpoint. The client device can then receive, from the webhook endpoint, the information about the network address based on the authentication information about the client device provided by the video conference provider. For example, the application may provide a webhook endpoint that can provide information used to populate the unfurled network address (e.g., images, text, links, etc.) based on the information about particular client devices and their respective authentication or authorization status. This configuration can, in effect, locate some functionality of the network address unfurling engine 420 to the server providing the webhook endpoint.

At block 940, the client device generates a rendering of the information about the network address. The rendering may include one or more controls, each control associated with an action to take in response to selecting the control. For example, the information about the network address may include an HTML template that includes conditional logic to display user controls in accordance with the local installation status of the application on the various participating client devices. For example, FIG. 6 depicts an example in which the application is installed locally and the user controls are rendered to enable the participant to open the installed application. FIG. 7 depicts an example in which the application is not installed locally and the user controls are thus rendered to enable the participant to install the application as an integration into he video conference client software.

At block 950, the client device displays the rendering on a display of the client device. In some examples, the rendered information about the network address and associated controls may be displayed as an unfurled network address in a chat interface. Several examples and descriptions thereof are depicted in FIGS. 6-8. In addition to a chat interface, the unfurled network address may be rendered in whiteboards, calendars, email bodies, social media posts, forum threads, and so on.

At block 960, the client device receives an indication of a selection of a first control of the one or more controls. For example, for a client device that does not have the application installed locally, the participant using that client device may push a button such as the “Add app” button 725 of FIG. 7 to cause the installation of the application as an integration, a local native application, web browser plugin, and so on.

At block 970, the client device outputs a command to execute the action associated with the first control. For example, the client device may use a command provided by the API of the video conference client software to initiate installation of a specified first-or third-party integration. In some examples, the client device may use a command provided by the API of the local operating system to initiate installation of a specified native desktop or mobile application. In some examples, the client device may prompt the user with an additional control (e.g., a radio button menu) to specify the type of installation to execute.

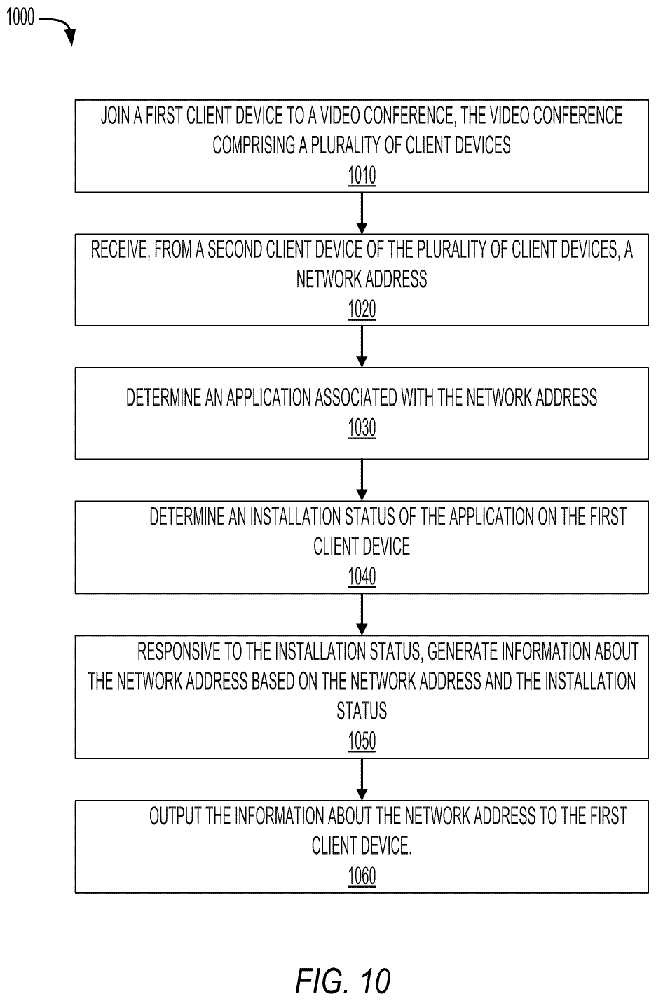

Referring now to FIG. 10, FIG. 10 shows a flowchart of another example method 1000 for providing shared application contexts during video conferences by a server such as a video conference provider 402, according to some aspects of the present disclosure. The description of the method 1000 in FIG. 10 will be made with reference to FIGS. 4-8, however any suitable system according to this disclosure may be used, such as the example systems 100 and 200, shown in FIGS. 1 and 2.

It should be appreciated that method 1000 provides a particular method for providing shared application contexts during video conferences. Other sequences of operations may also be performed according to alternative examples. For example, alternative examples of the present disclosure may perform the steps outlined above in a different order. Moreover, the individual operations illustrated by method 1000 may include multiple sub-operations that may be performed in various sequences as appropriate to the individual operation. Furthermore, additional operations may be added or removed depending on the particular applications. Further, the operations described in method 1000 may be performed by different devices. For example, the description is given from the perspective of a video conference provider (e.g., video conference provider 402) but other configurations are possible. One of ordinary skill in the art would recognize many variations, modifications, and alternatives.

The method 1000 may include block 1010. At block 1010, a video conference provider joins a first client device to a video conference, the video conference including a number of client devices. For example, a first client device may generate a video conference configuration and send it to the video conference provider. The video conference provider can then instantiate the meeting and enable additional client devices to join. The first client device may, for example, send invitations to other client devices to join the video conference. The video conference provider can coordinate the multiplexed sending and receiving of audio stream, video streams, chat communications, and so on, among the various connected client devices.

At block 1020, the video conference provider receives, from a second client device of the number of client devices, a network address. For example, the video conference provider can process received chat messages prior to sending from one client device to another. The processing may include, for example, unfurling of network addresses detected in the chat messages. In some examples, chat messages between or among the client devices is end-to-end encrypted. In that case, the client device may detect the presence of a network address in an incoming or outgoing chat message and separately transmit the network address to a suitable network address unfurling engine (e.g., the network address unfurling engine 420 of FIGS. 4 and 5), thus maintaining the security of the chat messages.

At block 1030, the video conference provider determines an application associated with the network address. For example, the video conference provider may determine an application from the network address based on a portion of network address string, such as the hostname or domain name from a URL. In some examples, a portion of or all of the network address can be used as a key to look up the associated application in a component such as the application database 530 described with respect to FIG. 5.

At block 1040, the video conference provider determines an installation status of the application on the first client device. For example, upon installation of the application integrations with video conference client software, client devices may send an indication of the installation to the video conference provider or other suitable registry location. In some examples, the application database 530 described with respect to FIG. 5, may persist information about application installations. Information about application installations can be similarly persisted for native desktop installation, mobile applications, web application account creation, and so on.

At block 1050, the video conference provider, responsive to the installation status, generates information about the network address based on the network address and the installation status. For example, the video conference provider can use components such as the application content retriever 540 and network address information generator 550 described with respect to FIG. 5 to generate and populate a suitable data structure to return to the video conference participant client devices to unfurl the network addresses.

The data structure may include various elements for displaying or rendering an unfurled network address including the information about the network address. For example, the data structure may include instructions for rendering the information about the network address. The instructions for rendering the information about the network address may be an HTML template or templates based on web development frameworks such as Handlebars, Jinja, or React. The information about the network address may further include an image or snapshot of the application, a title of the application, example text from the application, a description of the application, the developer or publisher name, application version, supported platforms, cost information, category or genre information, links for additional information, and so on.

At block 1060, the video conference provider outputs the information about the network address to the first client device. For example, the video conference provider can sent the information about the network address to each participant client device. The particular information sent to each client device may vary depending on information known about each respective client device such as application installation status, client device or software version, participant login status, previous participant actions, preferences, or configurations, and so on.

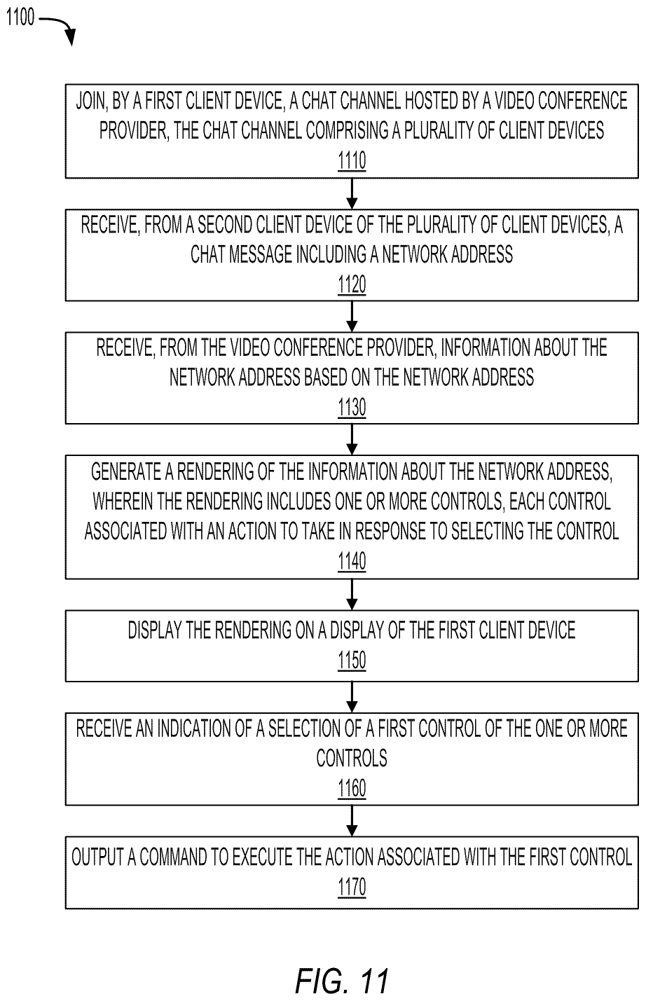

Referring now to FIG. 11, FIG. 11 shows a flowchart of yet another example method 1100 for providing shared application contexts during video conferences by a client device in a chat channel, according to some aspects of the present disclosure. The description of the method 1100 in FIG. 11 will be made with reference to FIGS. 4-8, however any suitable system according to this disclosure may be used, such as the example systems 110 and 200, shown in FIGS. 1 and 2.

It should be appreciated that method 1100 provides a particular method for providing shared application contexts during video conferences. Other sequences of operations may also be performed according to alternative examples. For example, alternative examples of the present disclosure may perform the steps outlined above in a different order. Moreover, the individual operations illustrated by method 1100 may include multiple sub-operations that may be performed in various sequences as appropriate to the individual operation. Furthermore, additional operations may be added or removed depending on the particular applications. Further, the operations described in method 1100 may be performed by different devices. For example, the description is given from the perspective of a client device (e.g., client device 410) but other configurations are possible. One of ordinary skill in the art would recognize many variations, modifications, and alternatives.

The method 1100 may include block 1100. At block 1100, a client device joins a chat channel hosted by a video conference provider, the chat channel including a number of client devices. The chat channel may include a number of participating client devices. Various chat channel participants may be using the respective client devices and may further desire to initiate a collaborative session over an application such as a word processor, graphics editor, web browser, video editing application, among many other possibilities, similar to block 910 above with respect to FIG. 9. Each application may have numerous corresponding implementations as described above in block 910 above with respect to FIG. 9.

At block 1120, the client device receives, from another client device of the number of client devices, a chat message including a network address. For example, a participant may desire to collaborate using an application during the chat channel session. Block 1120 can proceed similarly to the description of block 920 above with respect to FIG. 9.

At block 1130, the client device receives, from the video conference provider, information about the network address based on the network address, which can proceed similarly to the description of in block 930 above with respect to FIG. 9.

At block 1140, the client device generates a rendering of the information about the network address, in which the rendering includes one or more controls and in which each control is associated with an action to take in response to selecting the control, similar to the description of in block 940 above with respect to FIG. 9.

At block 1150, the client device displays the rendering on a display of the client device, similar to the description of in block 950 above with respect to FIG. 9. In this case, the unfurled network address, including the information about the network address, can be displayed in the chat channel, similarly to the chat function 620 shown in FIG. 6 or the chat channel shown in FIG. 8.

At block 1160, the client device receives an indication of a selection of a first control of the one or more controls, which can proceed similarly to the description of in block 960 above with respect to FIG. 9.

At block 1170, the client device outputs a command to execute the action associated with the first control, similarly to the description of in block 970 above with respect to FIG. 9.

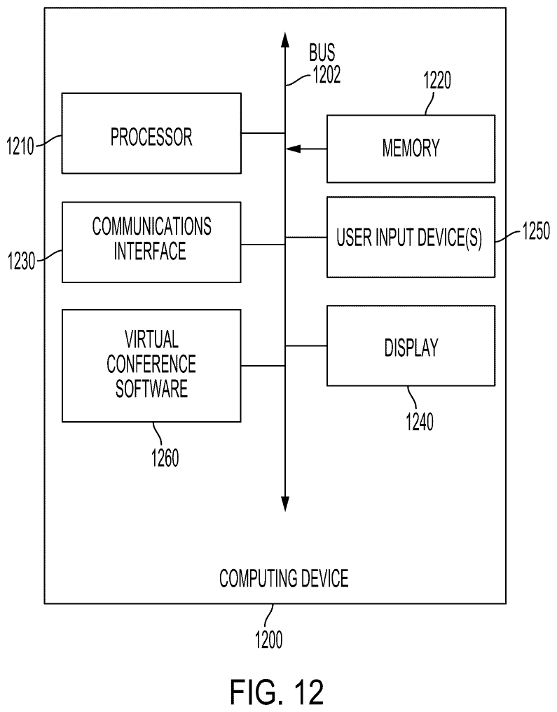

Referring now to FIG. 12, FIG. 12 shows an example computing device 1200 suitable for use in example systems or methods for providing shared application contexts during video conferences according to this disclosure. The example computing device 1200 includes a processor 1210 which is in communication with the memory 1220 and other components of the computing device 1200 using one or more communications buses 1202. The processor 1210 is configured to execute processor-executable instructions stored in the memory 1220 to perform one or more methods for providing shared application contexts during video conferences according to different examples, such as part or all of the example methods 900, 1000, 1100 described above with respect to FIGS. 9, 10, and 11. The computing device 1200, in this example, also includes one or more user input devices 1250, such as a keyboard, mouse, touchscreen, microphone, etc., to accept user input. The computing device 1200 also includes a display 1240 to provide visual output to a user.

In addition, the computing device 1200 includes virtual conferencing software 1260 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 1200 also includes a communications interface 1230. In some examples, the communications interface 1230 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method, comprising: joining, by a first client device, a video conference hosted by a video conference provider, the video conference comprising a plurality of client devices; receiving, from a second client device of the plurality of client devices, a network address; receiving, from the video conference provider, information about the network address based on the network address; generating a rendering of the information about the network address, wherein the rendering includes one or more controls, each control associated with an action to take in response to selecting the control; displaying the rendering on a display of the first client device; receiving an indication of a selection of a first control of the one or more controls; and outputting a command to execute the action associated with the first control.

Example 2 is the method of example(s) 1, wherein: the network address corresponds to a webpage; and the one or more controls include: a second control to cause the webpage to open in a collaborative web browser on each client device of the plurality of client devices; and a third control to cause the webpage to open in a preview web browser on the first client device.

Example 3 is the method of example(s) 1, wherein: the network address corresponds to a webpage; and the information about the network address includes instructions for rendering the information about the network address, including a preview of the webpage comprising an image of the webpage, a title of the webpage, and at least a portion of a text from the webpage.

Example 4 is the method of example(s) 1, wherein: the network address corresponds to an application; the application is not installed on the first client device; and the one or more controls include a second control to cause the application to be installed on the first client device.

Example 5 is the method of example(s) 1, wherein: the network address corresponds to an application; the application is installed on the first client device; and the one or more controls include: a second control to cause the application to open in a collaborative mode on each client device of the plurality of client devices; and a third control to cause the application to open on the first client device.

Example 6 is the method of example(s) 1, wherein: the network address corresponds to an application; and the information about the network address includes second information about the application based on the network address.

Example 7 is the method of example(s) 6, wherein the information about the network address further includes instructions for rendering the information about the network address, including a preview of the application based on the network address.

Example 8 is the method of example(s) 7, wherein the preview of the application is further based on information about the first client device.

Example 9 is the method of example(s) 1, wherein: the network address corresponds to an application; and the information about the network address includes default information about the application.

Example 10 is a non-transitory computer-readable medium storing instructions that, when executed by one or more processors, cause the one or more processors to perform operations including: joining, by a first client device, a video conference hosted by a video conference provider, the video conference comprising a plurality of client devices; receiving, from a second client device of the plurality of client devices, a network address; receiving, from the video conference provider, information about the network address based on the network address; generating a rendering of the information about the network address, wherein the rendering includes one or more controls, each control associated with an action to take in response to selecting the control; displaying the rendering on a display of the first client device; receiving an indication of a selection of a first control of the one or more controls; and outputting a command to execute the action associated with the first control.

Example 11 is the non-transitory computer-readable medium of example(s) 10, wherein: the network address is a uniform resource locator (URL) corresponding to a webpage; and the one or more controls include: a second control to cause the webpage to open in a collaborative web browser on each client device of the plurality of client devices; a third control to cause the webpage to open in a preview web browser on the first client device; and a fourth control to cause the webpage to open in a web browser application installed on the first client device.

Example 12 is the non-transitory computer-readable medium of example(s) 10, wherein: the network address corresponds to a webpage; the information about the network address includes instructions for rendering the information about the network address, including a preview of the webpage comprising an image of the webpage, a title of the webpage, and at least a portion of a text from the webpage; and the network address comprises authentication or authorization information.

Example 13 is the non-transitory computer-readable medium of example(s) 10, wherein: the network address is a uniform resource locator (URL) corresponding to an application, a portion of the URL being registered with an operating system of the first client device in response to an installation of the application on the first client device; and the one or more controls include: a second control to cause the application to open in a collaborative mode on each client device of the plurality of client devices; and a third control to cause the application to open on the first client device.

Example 14 is the non-transitory computer-readable medium of example(s) 10, wherein: the network address corresponds to an application; the application is installed in a video conference client software of the first client device; and the one or more controls include: a second control to cause the application to open in a collaborative mode on each client device of the plurality of client devices; and a third control to cause the application to open on the first client device, the opened application included in a video conference interface corresponding to the video conference.

Example 15 is a system comprising: one or more processors; and one or more computer-readable storage media storing instructions which, when executed by the one or more processors, cause the one or more processors to perform operations including: joining, by a first client device, a video conference hosted by a video conference provider, the video conference comprising a plurality of client devices; receiving, from a second client device of the plurality of client devices, a network address; receiving, from the video conference provider, information about the network address based on the network address; generating a rendering of the information about the network address, wherein the rendering includes one or more controls, each control associated with an action to take in response to selecting the control; displaying the rendering on a display of the first client device; receiving an indication of a selection of a first control of the one or more controls; and outputting a command to execute the action associated with the first control.

Example 16 is the system of example(s) 15, wherein: the network address corresponds to an application; and the information about the network address includes information about the application based on the network address.

Example 17 is the system of example(s) 16, wherein: the network address is a uniform resource locator (URL); the URL includes a portion corresponding to the application; the information about the network address further includes instructions for rendering the information about the network address, including a preview of the application based on the network address; and the preview of the application is further based on information about the first client device.

Example 18 is the system of example(s) 15, wherein the first client device includes a chat interface and receiving, from the second client device of the plurality of client devices, the network address comprises receiving a chat message including the network address using the chat interface.

Example 19 is the system of example(s) 15, wherein receiving, from the video conference provider, the information about the network address based on the network address comprises: outputting the network address to the video conference provider; receiving, from the video conference provider, a scope associated with the network address, wherein the scope is associated with an authentication information request; outputting, to the video conference provider, authentication information about the first client device; and receiving, from the video conference provider, the information about the network address based on the authentication information about the first client device.

Example 20 is the system of example(s) 15, wherein receiving, from the video conference provider, the information about the network address based on the network address comprises: outputting the network address and authentication information about the first client device to a webhook endpoint; and receiving, from the webhook endpoint, the information about the network address based on the authentication information about the first client device.

That which is claimed is:

1. A method, comprising:
joining, by a first client device, a video conference hosted by a video conference provider, the video conference comprising a plurality of client devices;
receiving, from a second client device of the plurality of client devices, a network address;
receiving, from the video conference provider, information about the network address based on the network address;
generating a rendering of the information about the network address, wherein the rendering includes one or more controls, each control associated with an action to take in response to selecting the control;
displaying the rendering on a display of the first client device;
receiving an indication of a selection of a first control of the one or more controls; and
outputting a command to execute the action associated with the first control.

2. The method of claim 1, wherein:
the network address corresponds to a webpage; and
the one or more controls include:
a second control to cause the webpage to open in a collaborative web browser on each client device of the plurality of client devices; and
a third control to cause the webpage to open in a preview web browser on the first client device.

3. The method of claim 1, wherein:
the network address corresponds to a webpage; and
the information about the network address includes instructions for rendering the information about the network address, including a preview of the webpage comprising an image of the webpage, a title of the webpage, and at least a portion of a text from the webpage.

4. The method of claim 1, wherein:
the network address corresponds to an application;
the application is not installed on the first client device; and
the one or more controls include a second control to cause the application to be installed on the first client device.

5. The method of claim 1, wherein:
the network address corresponds to an application;
the application is installed on the first client device; and
the one or more controls include:
a second control to cause the application to open in a collaborative mode on each client device of the plurality of client devices; and
a third control to cause the application to open on the first client device.

6. The method of claim 1, wherein:
the network address corresponds to an application; and
the information about the network address includes second information about the application based on the network address.

7. The method of claim 6, wherein the information about the network address further includes instructions for rendering the information about the network address, including a preview of the application based on the network address.

8. The method of claim 7, wherein the preview of the application is further based on information about the first client device.

9. The method of claim 1, wherein:
the network address corresponds to an application; and
the information about the network address includes default information about the application.

10. A non-transitory computer-readable medium storing instructions that, when executed by one or more processors, cause the one or more processors to perform operations including:
joining, by a first client device, a video conference hosted by a video conference provider, the video conference comprising a plurality of client devices;
receiving, from a second client device of the plurality of client devices, a network address;
receiving, from the video conference provider, information about the network address based on the network address;
generating a rendering of the information about the network address, wherein the rendering includes one or more controls, each control associated with an action to take in response to selecting the control;
displaying the rendering on a display of the first client device;
receiving an indication of a selection of a first control of the one or more controls; and
outputting a command to execute the action associated with the first control.

11. The non-transitory computer-readable medium of claim 10, wherein:
the network address is a uniform resource locator (URL) corresponding to a webpage; and
the one or more controls include:
a second control to cause the webpage to open in a collaborative web browser on each client device of the plurality of client devices;
a third control to cause the webpage to open in a preview web browser on the first client device; and
a fourth control to cause the webpage to open in a web browser application installed on the first client device.

12. The non-transitory computer-readable medium of claim 10, wherein:
the network address corresponds to a webpage;
the information about the network address includes instructions for rendering the information about the network address, including a preview of the webpage comprising an image of the webpage, a title of the webpage, and at least a portion of a text from the webpage; and
the network address comprises authentication or authorization information.

13. The non-transitory computer-readable medium of claim 10, wherein:
the network address is a uniform resource locator (URL) corresponding to an application, a portion of the URL being registered with an operating system of the first client device in response to an installation of the application on the first client device; and
the one or more controls include:
a second control to cause the application to open in a collaborative mode on each client device of the plurality of client devices; and
a third control to cause the application to open on the first client device.

14. The non-transitory computer-readable medium of claim 10, wherein:
the network address corresponds to an application;
the application is installed in a video conference client software of the first client device; and
the one or more controls include:
a second control to cause the application to open in a collaborative mode on each client device of the plurality of client devices; and
a third control to cause the application to open on the first client device, the opened application included in a video conference interface corresponding to the video conference.

15. A system comprising:
one or more processors; and
one or more computer-readable storage media storing instructions which, when executed by the one or more processors, cause the one or more processors to perform operations including:
joining, by a first client device, a video conference hosted by a video conference provider, the video conference comprising a plurality of client devices;
receiving, from a second client device of the plurality of client devices, a network address;
receiving, from the video conference provider, information about the network address based on the network address;
generating a rendering of the information about the network address, wherein the rendering includes one or more controls, each control associated with an action to take in response to selecting the control;
displaying the rendering on a display of the first client device;
receiving an indication of a selection of a first control of the one or more controls; and
outputting a command to execute the action associated with the first control.

16. The system of claim 15, wherein:
the network address corresponds to an application; and
the information about the network address includes information about the application based on the network address.

17. The system of claim 16, wherein:
the network address is a uniform resource locator (URL);
the URL includes a portion corresponding to the application;
the information about the network address further includes instructions for rendering the information about the network address, including a preview of the application based on the network address; and
the preview of the application is further based on information about the first client device.

18. The system of claim 15, wherein the first client device includes a chat interface and receiving, from the second client device of the plurality of client devices, the network address comprises receiving a chat message including the network address using the chat interface.

19. The system of claim 15, wherein receiving, from the video conference provider, the information about the network address based on the network address comprises:
outputting the network address to the video conference provider;
receiving, from the video conference provider, a scope associated with the network address, wherein the scope is associated with an authentication information request;
outputting, to the video conference provider, authentication information about the first client device; and
receiving, from the video conference provider, the information about the network address based on the authentication information about the first client device.

20. The system of claim 15, wherein receiving, from the video conference provider, the information about the network address based on the network address comprises:
outputting the network address and authentication information about the first client device to a webhook endpoint; and
receiving, from the webhook endpoint, the information about the network address based on the authentication information about the first client device.
